(19) United States
(12) Patent Application Publication
(10) Pub. No.: US 2015/0286514 A1
(43) Pub. Date: Oct. 8, 2015

(54) IMPLEMENTING TIERED PREDICTIVE FAILURE ANALYSIS AT DOMAIN INTERSECTIONS

(71) Applicant: International Business Machines Corporation, Armonk, NY (US)

(72) Inventor: Calvin D. Ward, Rochester, MN (US)

(21) Appl. No.: 14/312,485

(22) Filed: Jun. 23, 2014

Related U.S. Application Data
(63) Continuation of application No. 14/246,226, filed on Apr. 7, 2014.

(51) Int. Cl. G06F 11/07

(52) U.S. Cl. CPC G06F 11/076; G06F 11/0793

(57) ABSTRACT

A method and apparatus are provided for implementing enhanced tiered Predictive Failure Analysis (PFA) at domain intersections in a computer system. When recoverable errors trigger PFA calculations on an individual threshold unit, PFA calculations are performed on the individual threshold unit. A threshold domain of all intersection hardware with the individual threshold unit is established. PFA calculations are performed on all intersection hardware in the threshold domain. A repair action is triggered based upon comparing the PFA calculations for the individual threshold unit and comparing the PFA calculations for each intersection hardware.

This application is a continuation application of 14/246,226 filed Apr. 7, 2014.

### FIELD OF THE INVENTION

The present invention relates generally to the data processing field, and more particularly, relates to method and apparatus for implementing enhanced tiered Predictive Failure Analysis (PFA) at domain intersections in a computer system.

### DESCRIPTION OF THE RELATED ART

Typically Predictive Failure Analysis (PFA) includes the thresholding of recoverable errors on hardware where a predefined number of errors in a predefined interval of time are counted and tolerated. When the count passes the tolerated level, events are triggered which culminate in a notification to the customer that service is needed. The thresholding metrics used are intended to call for service before a failure or outage occurs in the problem hardware. The nature of PFA is that the component causing the errors remains functioning and therefore after the part is replaced it is difficult to be sure that the problem has been solved until, over time, it is clear that the number of tolerated faults is nominal.

A problem is that conventional Predictive Failure Analysis (PFA) tends to focus on tolerated faults being detected and ascribed to a component that the error detection is designed to monitor. For well contained and well isolated faults such PFA works well.

Without the certainty of knowing which specific component of multiple possible components is having errors, the efficacy of the repair action is reduced. In other words, when the detection point of intermittent faults is such that multiple hardware components make up the failure domain with varying degrees of likelihood then an error event that triggers a repair action must call out multiple part candidates for the service action.

When isolation is not to a single component, replacing the most likely of the hardware components may not have resolved the problem but some period of time may be necessary to make that determination. Replacing all the suspect parts increases the cost of the repair action thus the repair actions tend to focus on replacing only the most likely part.

A need exists for an efficient and effective method and apparatus for implementing enhanced tiered Predictive Failure Analysis (PFA) at domain intersections in a computer system.

### SUMMARY OF THE INVENTION

Principal aspects of the present invention are to provide a method and apparatus for implementing enhanced tiered Predictive Failure Analysis (PFA) at domain intersections in a computer system. Other important aspects of the present invention are to provide such method and apparatus substantially without negative effects and that overcome many of the disadvantages of prior art arrangements.

In brief, a method and apparatus are provided for implementing enhanced tiered Predictive Failure Analysis (PFA) at domain intersections in a computer system. When recoverable errors trigger PFA calculations on an individual threshold unit, PFA calculations are performed on the individual threshold unit. A threshold domain of all intersection hardware with the individual threshold unit is established. PFA calculations are performed on all intersection hardware in the threshold domain. A repair action is triggered based upon comparing the PFA calculations for the individual threshold unit and comparing the PFA calculations for each intersection hardware.

In accordance with features of the invention, the recoverable error data count of the intersection hardware is equal to or higher than the recoverable error data count of any individual threshold unit in a domain.

In accordance with features of the invention, when the individual threshold unit is at a service point, the service action triggered includes a repair action to replace the individual threshold unit.

In accordance with features of the invention, when the PFA calculations for intersection hardware trigger a service action, the error identifier and service action calls for replacement of the intersection hardware sooner than any individual unit and avoiding the unnecessary replacement of any of the individual threshold units.

In accordance with features of the invention, when any intersection hardware is at a service point, the service action triggered includes a repair action to replace that intersection hardware.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram of an example computer system for implementing enhanced tiered Predictive Failure Analysis (PFA) at domain intersections in accordance with a preferred embodiment;

FIG. 2 is a block diagram of the example intersecting targeted failure domains used for implementing enhanced tiered Predictive Failure Analysis (PFA) at domain intersections in accordance with a preferred embodiment;

FIG. 3 is a flow chart illustrating example system operations of the computer system of FIG. 1 for implementing enhanced tiered (Predictive Failure Analysis) PFA at domain intersections in accordance with a preferred embodiment;

FIG. 4 is a block diagram illustrating a computer program product in accordance with the preferred embodiment.

### DETAILED DESCRIPTION OF THE PREFERRED EMBODIMENTS

In the following detailed description of embodiments of the invention, reference is made to the accompanying drawings, which illustrate example embodiments by which the invention may be practiced. It is to be understood that other embodiments may be utilized and structural changes may be made without departing from the scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In accordance with features of the invention, a method and apparatus are provided for implementing enhanced tiered Predictive Failure Analysis at domain intersections in a computer system.

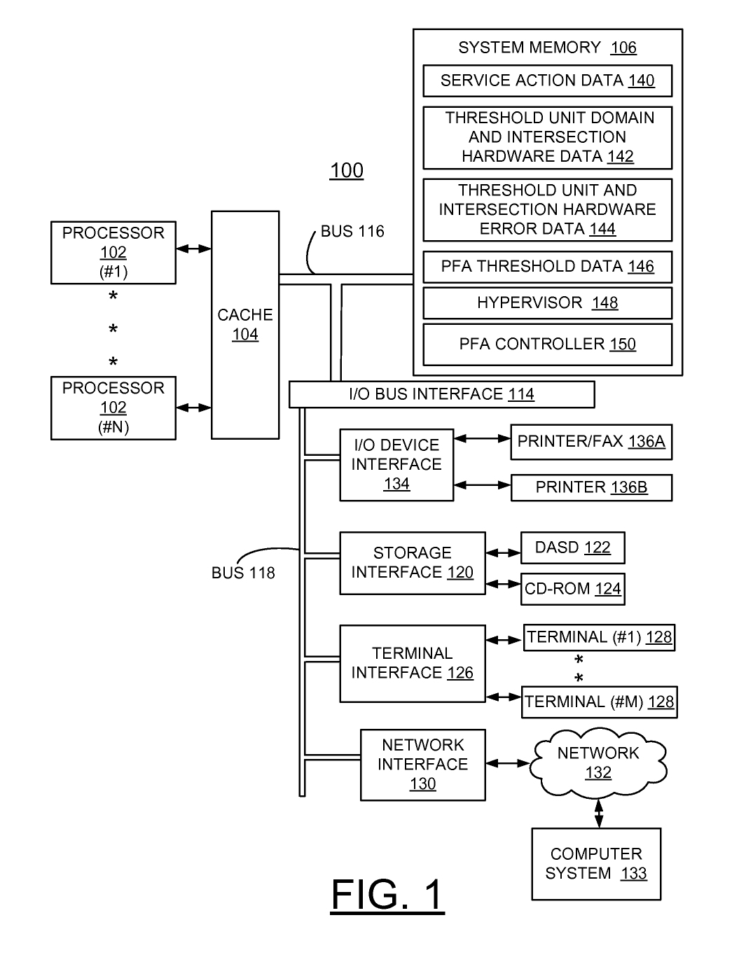

Having reference now to the drawings, in FIG. 1, there is shown a computer system embodying the present invention generally designated by the reference character 100 for implementing enhanced tiered Predictive Failure Analysis at domain intersections in accordance with the preferred embodiment. Computer system 100 includes one or more processors 102 or general-purpose programmable central processing units (CPUs) 102, #1-N. As shown, computer system 100 includes multiple processors 102 typical of a relatively large system; however, system 100 can include a single CPU 102. Computer system 100 includes a cache memory 104 connected to each processor 102.

Computer system 100 includes a system memory 106. System memory 106 is a random-access semiconductor memory for storing data, including programs. System memory 106 is comprised of, for example, a dynamic random access memory (DRAM), a synchronous direct random access memory (SDRAM), a current double data rate (DDRx) SDRAM, non-volatile memory, optical storage, and other storage devices.

I/O bus interface 114, and buses 116, 118 provide communication paths among the various system components. Bus 116 is a processor/memory bus, often referred to as front-side bus, providing a data communication path for transferring data among CPUs 102 and caches 104, system memory 106 and I/O bus interface unit 114. I/O bus interface 114 is further coupled to system I/O bus 118 for transferring data to and from various I/O units.

As shown, computer system 100 includes a storage interface 120 coupled to storage devices, such as, a direct access storage device (DASD) 122, and a CD-ROM 124. Computer system 100 includes a terminal interface 126 coupled to a plurality of terminals 128, #1-M, a network interface 130 coupled to a network 132, such as the Internet, local area or other networks, shown connected to another separate computer system 133, and a I/O device interface 134 coupled to I/O devices, such as a first printer/fax 136A, and a second printer 136B.

I/O bus interface 114 communicates with multiple I/O interface units 120, 126, 130, 134, which are also known as I/O processors (IOPs) or I/O adapters (IOAs), through system I/O bus 116. System I/O bus 116 is, for example, an industry standard PCI bus, or other appropriate bus technology.

System memory 106 stores service action data 140, threshold unit domain and intersection hardware data 142, threshold unit domain and intersection hardware error data 144, PFA threshold data 146, a hypervisor 148, and a PFA controller 150 for implementing enhanced tiered Predictive Failure Analysis at domain intersections in a computer system in accordance with the preferred embodiments.

In accordance with features of the invention, implementing enhanced tiered Predictive Failure Analysis at domain intersections overcomes the drawback of conventional low level thresholding that focusses on tallying recoverable errors for a specific hardware unit where in some cases, the isolation of these errors is not 100% to the specific HW unit and other hardware can be implicated in the failure. Implementing enhanced tiered Predictive Failure Analysis at domain intersections of the invention, considers other possible hardware implicated in a failure, not being limited to a specific hardware unit of conventional arrangements.

In accordance with features of the invention, build into the PFA diagnostic code that does PFA thresholding is the knowledge that a given error domain includes low probability implicated hardware common to multiple units of hardware being thresholded individually. In other words, the error domains of the individual thresholded units may have an intersection area or intersection hardware where a problem lies. To deal with this thresholding on the intersection hardware of the domains is established. Whenever recoverable errors trigger PFA calculations on a thresholded unit having a domain that contains the intersection area, then PFA calculations are performed on the intersection hardware also.

In accordance with features of the invention, each individually thresholded unit may be within tolerance but the total number of recoverable errors for the intersection hardware would always be equal to or higher than recoverable error count for any individual unit. Therefore the thresholding on the intersection hardware triggers service sooner than any individual unit with more than one individual unit presenting recoverable errors. When the PFA calculations for the intersection hardware trigger a service action, the error identifier and service action calls for the replacement of the intersection hardware sooner than any individual unit, avoiding the unnecessary replacement of any of the individually thresholded units.

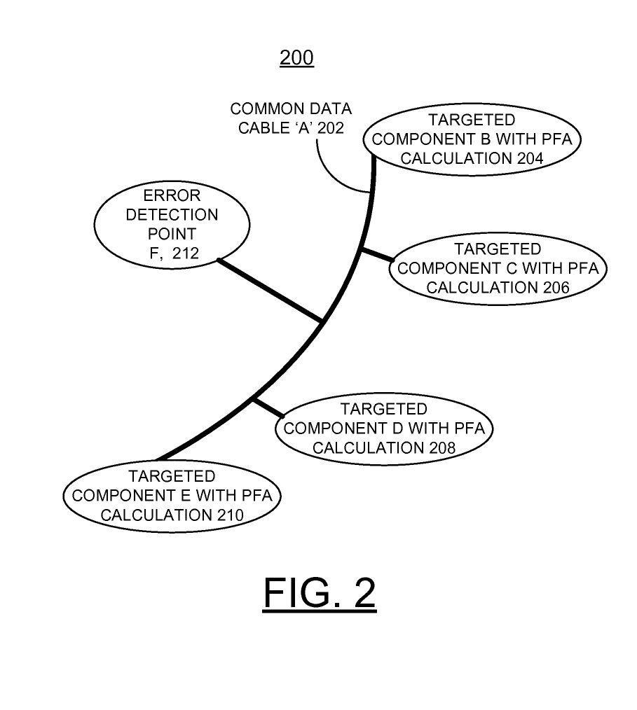

Referring to FIG. 2, there are shown example system operations designated by the reference character 200 with an example common data cable A, 202 the computer system 100 in accordance with a preferred embodiment. As shown, system operations 200 include example targeted components with PFA calculations B, 204; C, 206; D, 208; and E, 210 and an error detection point F, 212, and include PFA calculations for the example common data cable A, 202.

As shown in FIG. 2, components B, 204; C, 206; D, 208; and E, 210 all have PFA calculation being done based on faults detected in data at an error point, such as error detection point F, 212. The failure domains of each targeted components B, 204; C, 206; D, 208; and E, 210 are the respective targeted component B, 204; C, 206; D, 208; E, 210 plus cable A, 202 which spans between the detection point F, 212 and fans out to each targeted component B, 204; C, 206; D, 208; and E, 210. When any of the PFA targeted components B, 204; C, 206; D, 208; or E, 210 exceeds its number of tolerated faults the suspect parts for replacement are the particular targeted component and the cable A, 202. Assume that the failure probability of the cable A, 202 is minimal and that its relative cost is high making the replacement of the cable cost ineffective whenever a targeted component is replaced.

In the example system operations 200, if the cable A, 202 were experiencing intermittent faults; those faults would be detected, for example, at the error detection point F, 212. The error detection point F, 212 is aware of which targeted component B, 204; C, 206; D, 208; or E, 210 is driving data over the cable at the time the fault is detected. Each time a fault is detected; the PFA algorithm or PFA controller 150 notes the target device and calculates the PFA for that target component. When replacement is warranted the PFA controller 150 triggers the necessary events in the system to cause a call for a service action on the component. The cable A, 202 may or may not be included as an implicated part for the service provider to replace at their discretion.

In accordance with features of the invention, the PFA algorithm or PFA controller 150 effectively accounts for the shared cable A, 202, with the tolerated faults for the shared cable also calculated as a PFA calculation with the same metrics as the targeted components B, 204; C, 206; D, 208; and E, 210. If only one targeted component B, 204; C, 206; D, 208; or E, 210 is experiencing faults the PFA controller 150 favors a service action on the component rather than the cable A, 202. However, if multiple ones of the targeted components B, 204; C, 206; D, 208; E, 210 are experiencing faults the PFA calculations are more frequent on the cable A, 202 and the PFA controller 150 will therefore conclude that the cable A, 202 should be replaced before any of the targeted components is identified for replacement.

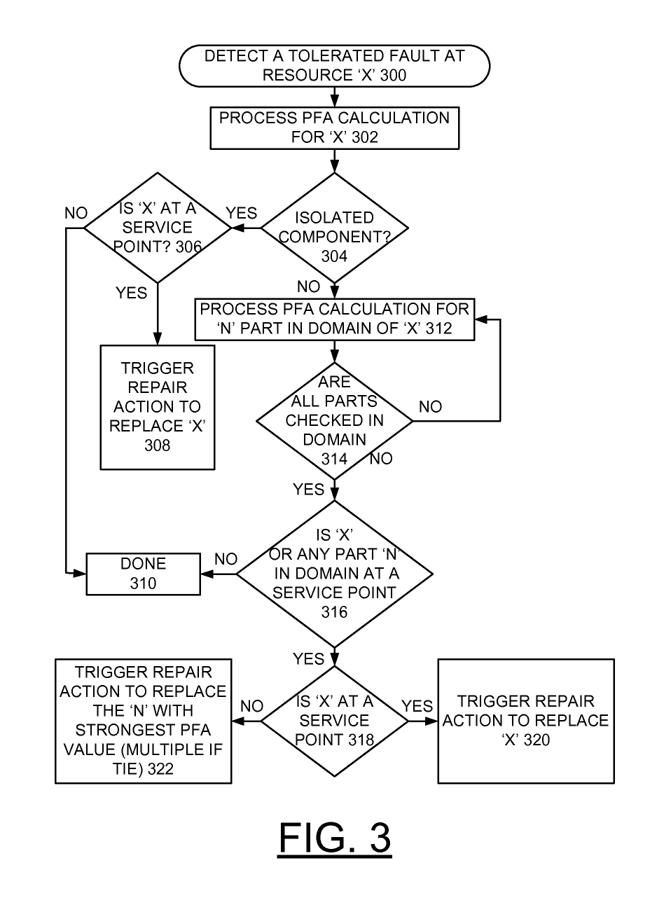

Referring to FIG. 3, there are shown example system operations of the computer system 100 for implementing enhanced tiered (Predictive Failure Analysis) PFA at domain intersections in accordance with a preferred embodiment.

As indicated at a block 300, a tolerated fault at a resource X is detected. PFA calculations are performed on the threshold unit resource X as indicated at a block 302. Checking whether the threshold unit resource X is an isolated component as indicated at a decision block 304. When the threshold unit resource X is an isolated component, then checking is performed to determine if threshold unit resource X is at a service point as indicated at a decision block 306. When the threshold unit resource X is at a service point, a repair action is triggered to replace the threshold unit resource X as indicated at a block 308. Then the operations are completed as indicated at a block 310.

Otherwise with threshold unit resource X is not an isolated component; then as indicated at a block 312 and at a decision block 314, PFA calculations are performed on each part or each intersection hardware unit in the threshold unit domain of the threshold unit resource X.

In accordance with features of the invention, a service action is selectively triggered based upon comparing the PFA calculations with predefined service action data for the threshold, individual unit and for each intersection hardware.

As indicated at a decision block 316 after all parts have been checked in the threshold unit domain, checking is performed to determine if the threshold unit resource X or any intersection hardware unit in the threshold unit domain is at a service point. When the threshold unit resource X and all intersection hardware units in the threshold unit domain are not at a service point, then the operations are completed as indicated at a block 310.

Checking is performed to determine if threshold unit resource X is at a service point as indicated at a decision block 318. When the threshold unit resource X is at a service point, a repair action is triggered to replace the threshold unit resource X as indicated at a block 320. When the threshold unit resource X is not at a service point, a repair action is triggered to replace the intersection hardware unit in the threshold unit domain having the strongest or highest PFA value as indicated at a block 322. When the highest PFA value for two or more intersection hardware units, then the repair action is triggered to replace multiple intersection hardware units at block 322.

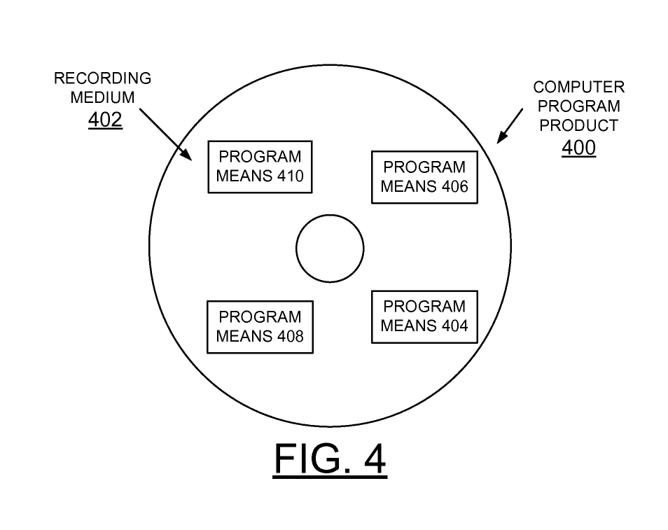

Referring now to FIG. 4, an article of manufacture or a computer program product 400 of the invention is illustrated. The computer program product 400 is tangibly embodied on a non-transitory computer readable storage medium that includes a recording medium 402, such as, a floppy disk, a high capacity read only memory in the form of an optically read compact disk or CD-ROM, a tape, or another similar computer program product. Recording medium 402 stores program means 404, 406, 408, and 410 on the medium 402 for carrying out the methods for implementing enhanced tiered Predictive Failure Analysis (PFA) at domain intersections of the preferred embodiment in the system 100 of FIG. 1.

A sequence of program instructions or a logical assembly of one or more interrelated modules defined by the recorded program means 404, 406, 408, and 410, direct the system 100 for implementing enhanced tiered Predictive Failure Analysis (PFA) at domain intersections of the preferred embodiment.

While the present invention has been described with reference to the details of the embodiments of the invention shown in the drawing, these details are not intended to limit the scope of the invention as claimed in the appended claims.

1-11. (canceled)

12. A computer-implemented method for implementing enhanced tiered Predictive Failure Analysis (PFA) at domain intersections in a computer system comprising the steps of:
identifying predefined recoverable errors and triggering PFA calculations on a individual threshold unit;
performing PFA calculations on the individual threshold unit;
establishing a threshold domain of all intersection hardware with the individual threshold unit;
performing PFA calculations on all intersection hardware; and
triggering a service action based upon comparing the PFA calculations for the individual threshold unit and for each intersection hardware with predefined service action data.

13. The method as recited in claim 12 includes a plurality of individual threshold units and includes storing a respective threshold domain of all intersection hardware with at least respective ones of the individual threshold units.

14. The method as recited in claim 12 includes storing individual threshold unit error data and intersection hardware error data.

15. The method as recited in claim 14 wherein storing individual threshold unit error data and intersection hardware error data includes storing recoverable errors for each of the plurality of the individual threshold units and the intersection hardware.

16. The method as recited in claim 15 includes storing a total number of recoverable errors for the intersection hardware greater than or equal to a number of recoverable errors for the individual threshold units.

17. The method as recited in claim 12 wherein triggering a service action includes triggering a repair action to replace the individual threshold unit when the individual threshold unit is at a service point.

18. The method as recited in claim 12 wherein triggering a service action includes triggering a repair action to replace intersection hardware having a highest PFA value when any intersection hardware is at a service point.

19. The method as recited in claim 12 includes triggering the service action to replace the intersection hardware before any individual threshold unit with more than one individual threshold units presenting recoverable errors.

20. The method as recited in claim 12 includes, responsive to only one individual threshold unit presenting recoverable errors, triggering the service action on the one individual threshold unit rather than the intersection hardware.
